(19) United States
(12) Patent Application Publication
(10) Pub. No.: US 2007/0102894 A1
(43) Pub. Date: May 10, 2007

(54) CASTER ADJUSTMENT APPARATUS AND METHOD

(76) Inventor: Santo Derisi, Casar, NC (US)

Correspondence Address: ADAMS EVANS P.A., 301 SOUTH TRYON STREET, SUITE 2180, TWO WACHOVIA CENTER, CHARLOTTE, NC, 28282-1991, US

(21) Appl. No.: 11/557,385

(22) Filed: Nov. 7, 2006

Related U.S. Application Data
(60) Provisional application No. 60/734,074, filed on Nov. 7, 2005.

(51) Int. Cl. B62D 17/00

(52) U.S. Cl. 280/86.751

(57) ABSTRACT

A caster adjustment apparatus for selectively adjusting the caster of a wheel of a vehicle. The caster adjustment apparatus including a flange and a cylindrical sleeve. The flange including an aperture extending through the flange for receiving a ball joint therethrough, wherein a center of the aperture is offset from a center of the flange, and a plurality of openings positioned around a periphery of the flange at predetermined positions for engagement with an engagement member positioned on the ball joint mount. The cylindrical sleeve extends from a bottom surface of the flange for being received in the ball joint mount.

### CROSS-REFERENCE TO RELATED APPLICATIONS

This application claims the benefit of Provisional Application No. 60/734,074, filed on Nov. 7, 2005.

### TECHNICAL FIELD AND BACKGROUND OF THE INVENTION

The present invention relates to the field of wheel caster adjustment. In particular, the invention relates to a caster adjustment apparatus, suspension member assembly, and method for selectively adjusting the caster of a wheel of a vehicle.

“Caster” is a term used to refer to the backward and forward tilt of the steering axis of a vehicle. Adjusting the caster of a wheel effects the way a vehicle handles. For example, adjusting the caster can maximize tire contact, improve turn-in, increase directional stability, and improve steering feel and self-center.

Various methods for adjusting caster have been developed and are employed on various types of vehicles. One such method is disclosed in U.S. Pat. No. 6,688,616. The method includes the use of cams and a fastener for adjusting the position of the control arm relative to a frame in the fore-aft direction. Other methods are complex and require a technician to perform the adjustment, require special tools, or require a substantial amount of time to perform the adjustment.

While most vehicles include some means for adjusting the caster of a wheel, some vehicles are manufactured with a preset caster that cannot be adjusted. For example, a conventional all-terrain vehicles (ATVs) are manufactured with a preset caster that cannot be adjusted. The suspension systems of the ATVs use upper and lower suspension members that are attached at one end to the frames of the ATVs and at the other end to the wheel hubs by ball joints. Thus, operators of the ATVs cannot adjust the caster to change handling characteristics. Such an adjustment would be beneficial in racing high-performance ATVs used under harsh conditions.

Accordingly, there is a need for a caster adjustment apparatus, suspension member assembly, and method that allows the caster of a wheel to be adjusted easily, in a short period of time without the use of special tools, and that can be used on vehicles that are manufactured without caster adjustment.

### SUMMARY OF THE INVENTION

Therefore, it is an object of the invention to provide a caster adjustment apparatus that allows the caster to be easily adjusted.

It is another object of the invention to provide a caster adjustment apparatus that can be used with racing or high-performance vehicles used under harsh conditions.

It is another object of the invention to provide a caster adjustment apparatus that can be used on vehicles without a caster adjustment.

It is another object of the invention to provide a caster adjustment apparatus that allows the caster to be adjusted in the positive and negative directions.

It is another object of the invention to provide a suspension member assembly that allows the caster to be easily adjusted.

These and other objects of the present invention are achieved in the preferred embodiments disclosed below by providing a caster adjustment apparatus for being positioned in a ball joint mount of a suspension member. The caster adjustment apparatus includes a flange having an aperture extending through the flange for receiving a ball joint therethrough, wherein a center of the aperture is offset from a center of the flange, and a plurality of openings positioned around a periphery of the flange at predetermined positions for engagement with an engagement member positioned on the ball joint mount. The caster adjustment apparatus also including a cylindrical sleeve extending from a bottom surface of the flange for being received in the ball joint mount.

According to another preferred embodiment of the invention, the openings are notches.

According to another preferred embodiment of the invention, the plurality of openings are spaced-apart in predetermined increments.

According to another preferred embodiment of the invention, the bottom surface of the flange is adapted to abut against the ball joint mount.

According to another preferred embodiment of the invention, the sleeve is adapted to be positioned within an aperture of the ball joint mount.

According to another preferred embodiment of the invention, the flange has a diameter greater than the diameter of the sleeve such that when the sleeve is positioned in the ball joint mount, the flange interferes with a top edge of the ball joint mount to provide a stop.

According to another preferred embodiment of the invention, a caster adjustment assembly includes a suspension member for being mounted between a vehicle frame and a vehicle wheel assembly. The suspension member includes a ball joint mount positioned for receiving a ball joint therein to connect the suspension member to the wheel assembly, and an engagement member positioned on the ball joint mount. The assembly also includes a first cam positioned in a fist side of the ball joint mount for receiving and adjusting the position of the ball joint. The cam includes a flange having an aperture extending through the flange for receiving the ball joint therethrough, and a plurality of openings positioned around a periphery of the flange at predetermined positions for engagement with the engagement member, wherein a center of the aperture is offset from a center of the flange, and a cylindrical sleeve extending from a bottom surface of the flange, the sleeve being received in the ball joint mount. At least one of the openings is engaged with the engagement member to secure the cam at a selected angular orientation relative to the ball joint mount.

According to another preferred embodiment of the invention, the engagement member is positioned on the first side of the ball joint mount.

According to another preferred embodiment of the invention, the plurality of openings are notches.

According to another preferred embodiment of the invention, a stud of the ball joint is positioned through the aperture.

According to another preferred embodiment of the invention, the assembly further includes a second cam positioned on a second side of the ball joint mount.

According to another preferred embodiment of the invention, the second cam includes a flange having an aperture extending through the flange for receiving the ball joint therethrough, and a plurality of openings positioned around a periphery of the flange at predetermined positions for engagement with an engagement member positioned on a second side of the ball joint mount, wherein a center of the aperture is offset from a center of the flange; and a cylindrical sleeve extending from a bottom surface of the flange, the sleeve being received in the ball joint mount.

According to another preferred embodiment of the invention, the plurality of openings are notches.

According to another preferred embodiment of the invention, the first cam and the second cam are positioned in opposing sides of the ball joint mount such that the apertures extending through the flanges are aligned to receive the ball joint therethrough.

According to another preferred embodiment of the invention, a method of adjusting the caster of a vehicle wheel includes the steps of providing a first caster adjustment apparatus having an aperture extending through a flange for receiving a ball joint therethrough; positioning the first caster adjustment apparatus in a ball joint mount; positioning the ball joint in the aperture; and securing the ball joint to the ball joint mount.

According to another preferred embodiment of the invention, the method further includes the step of removing a bushing from the ball joint mount.

According to another preferred embodiment of the invention, the method further includes the step of rotating the caster adjustment apparatus to a predetermined position such that an opening in a flange of the caster adjustment apparatus engages an engagement member on the ball joint mount.

According to another preferred embodiment of the invention, the method further includes the steps of providing a second caster adjustment apparatus having an aperture extending through a flange for receiving a ball joint therethrough; and positioning the second caster adjustment apparatus in a second opposing side of the ball joint mount.

According to another preferred embodiment of the invention, the method further includes the step of rotating the second caster adjustment apparatus such that the aperture of the second caster adjustment apparatus is aligned with the aperture of the first caster adjustment apparatus for receiving the ball joint therethrough.

According to another preferred embodiment of the invention, the method further includes the step of securing a wheel assembly to the ball joint.

### BRIEF DESCRIPTION OF THE DRAWINGS

The invention may be best understood by reference to the following description taken in conjunction with the accompanying drawing figures in which:

FIG. 1 is a perspective view of an all-terrain vehicle;

FIG. 2 shows a prior art suspension system of the all-terrain vehicle of FIG. 1;

FIG. 3 is a top view of a caster adjustment apparatus according to an embodiment of the invention;

FIG. 4 is a side view of the caster adjustment apparatus of FIG. 3;

FIG. 5 shows the caster adjustment apparatus of FIG. 3 and an upper suspension member of the suspension system of FIG. 2;

FIG. 6 is a cross-section of the caster adjustment apparatus of FIG. 3 inserted into a ball joint mount of the upper suspension member of FIG. 5;

FIG. 7 shows the caster adjustment apparatus of FIG. 3 used with the upper suspension member on the all-terrain vehicle of FIG. 1;

FIG. 8 shows the caster adjustment apparatus of FIG. 3 used with the upper and lower suspension members on the all-terrain vehicle of FIG. 1; and

FIG. 9 is an exploded view of a suspension member assembly according to an embodiment of the invention.

### DESCRIPTION OF THE PREFERRED EMBODIMENT AND BEST MODE

While this discussion is limited to a suspension system of an all-terrain vehicle (ATV), the present invention is applicable to any vehicle where adjustment of caster is desired.

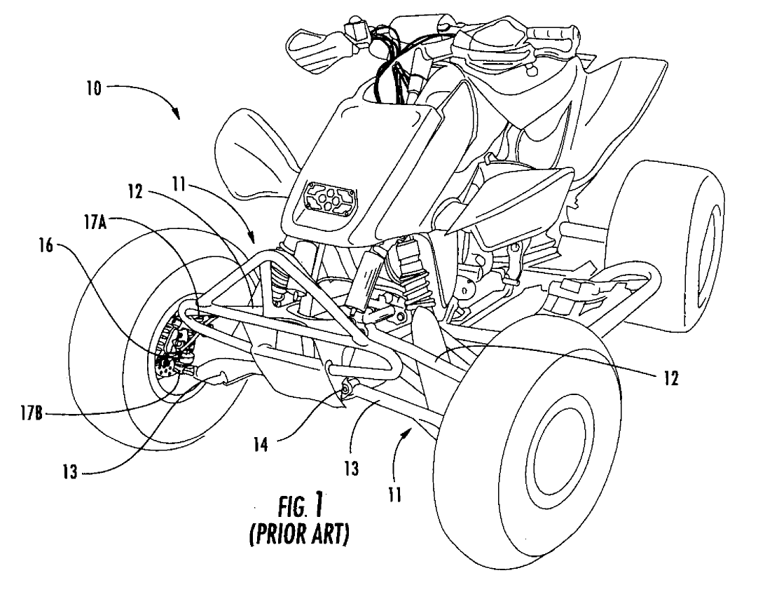

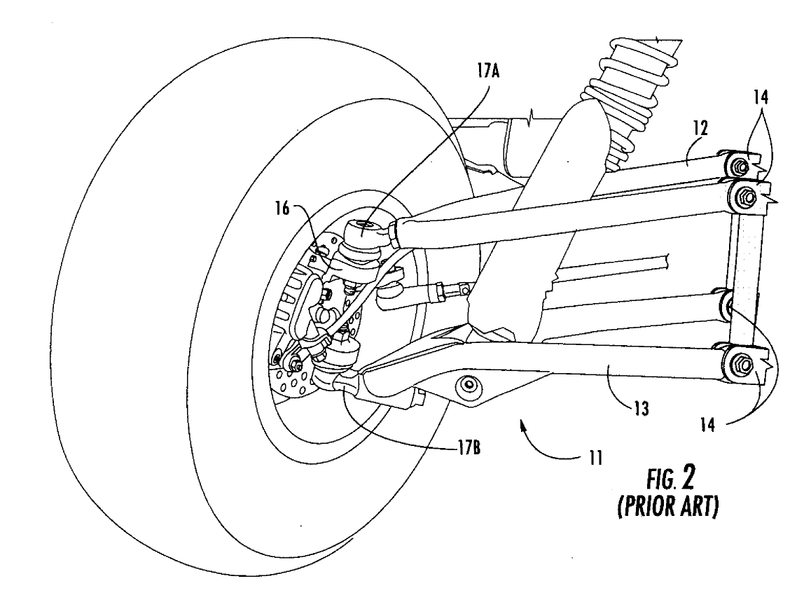

Referring now specifically to the drawings, a conventional all-terrain vehicle (ATV) having a suspension system with non-adjustable caster, is illustrated in FIG. 1 and shown generally at reference numeral 10. As shown in FIG. 2, the suspension system 11 of the ATV 10 uses upper 12 and lower 13 suspension members that are attached at one end to the frame 14 of the ATV 10 and at the other end to the wheel hub 16 by ball joints 17A and 17B. This type of suspension system does not allow adjustment of the caster, thereby forcing the operator to live with the preset handling characteristics mandated by the manufacturer.

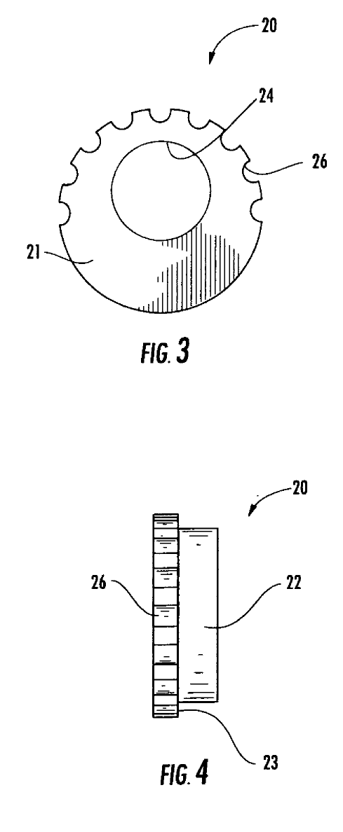

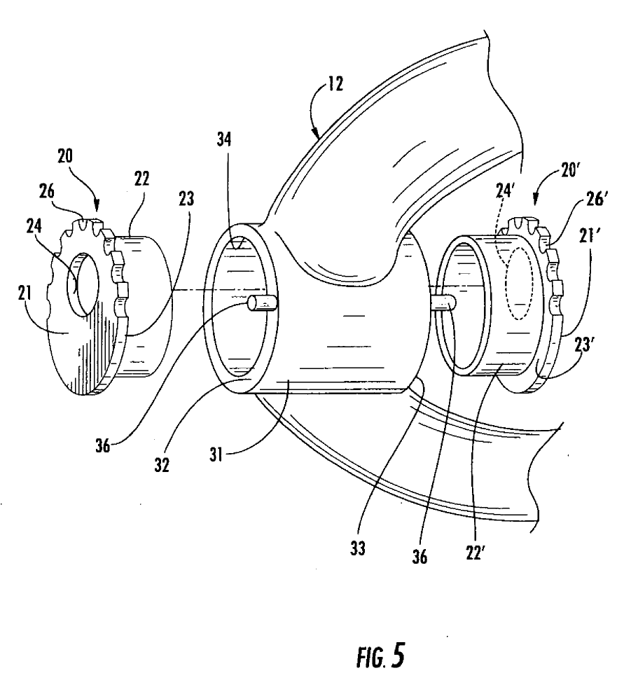

Referring to FIGS. 3 and 4, a caster adjustment cam according to an embodiment of the invention is shown generally at reference numeral 20. The cam 20 includes a flange 21 and a sleeve 22 extending from a bottom surface 23 of the flange 21. The flange 21 includes an off-axis aperture 24. A plurality of notches 26 are positioned around the periphery of the flange 21 and are spaced-apart in predetermined increments, for example, one-half degree, to allow minute adjustments of the cam 20.

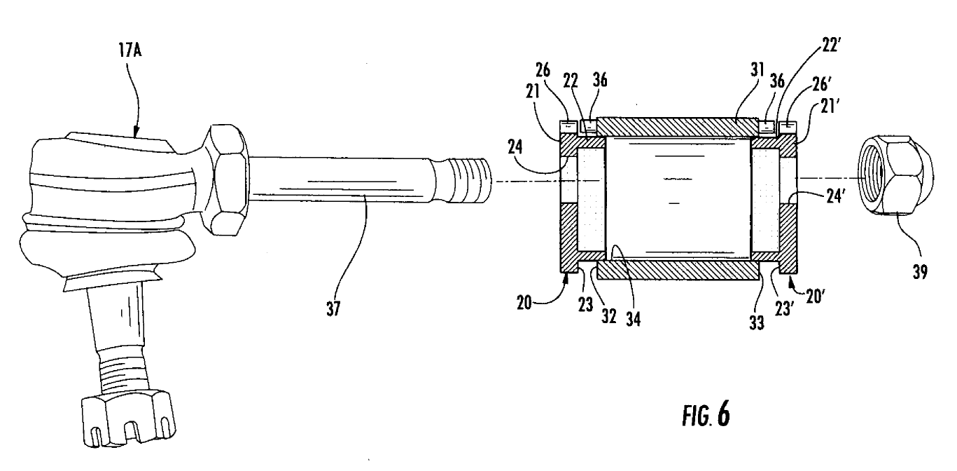

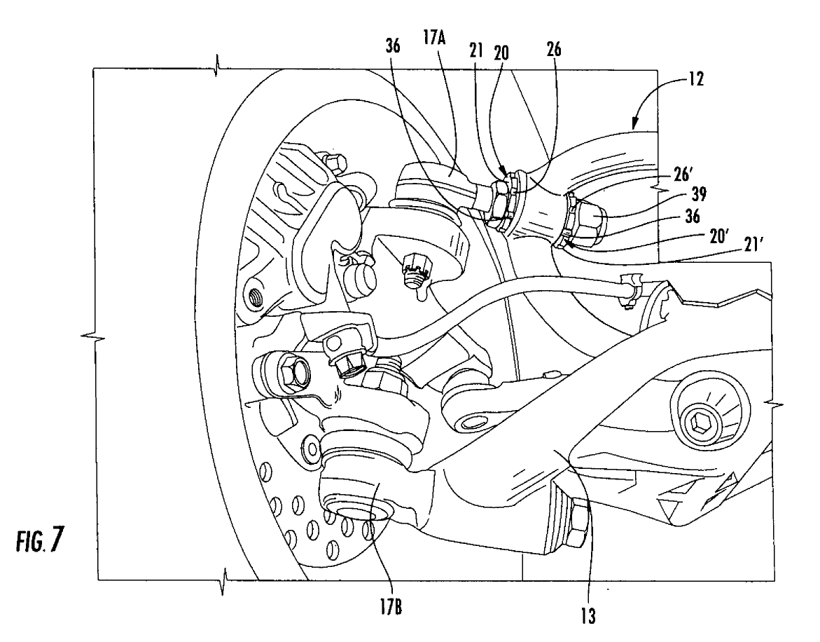

As shown in FIGS. 5 and 6, the cam 20 may be used with existing suspension members, such as upper suspension member 12 depicted in FIG. 2. As illustrated, suspension member 12 includes a ball joint mount 31 having a top surface 32, a bottom surface 33, and an aperture 34 extending through the ball joint mount 31 from the top surface 32 to the bottom surface 33. The suspension member 12 is modified to include an engagement member 36 extending from the top and bottom surfaces 32 and 33 of the ball joint mount 31.

The cam 20 is positioned such that a portion of the sleeve 22 is received in the aperture 34 of the ball joint mount 31, thereby allowing the bottom surface 23 of the flange 21 to rest adjacent to the top surface 32. The cam 20 is then rotated until a desired one of the notches 26 is aligned with the engagement member 36 extending from the top surface 32. The cam 20 is then pushed further into the aperture 34 until the bottom surface 23 of the flange 21 comes into contact with the top surface 32, thereby allowing the desired one of the notches 26 to engage the engagement member 36.

A second cam 20 ′ is positioned such that a portion of a sleeve 22′ thereof is received in the aperture 34, thereby allowing its surface 23′ to rest adjacent to the bottom surface 33. The second cam 20′ is then rotated so as to align an off-axis aperture 24′ with the off-axis aperture 24. The cam 20′ is then pushed further into the aperture 34 so that one of a plurality of notches 26′ engages the engagement member 36 extending from the bottom surface 33. As illustrated in FIG. 6, a post 37 of the ball joint 17A is then inserted through the off-axis apertures 24 and 24′ of the two cams 20 and 20′ and secured to the ball joint mount 31 by an attachment means, such as a nut 39.

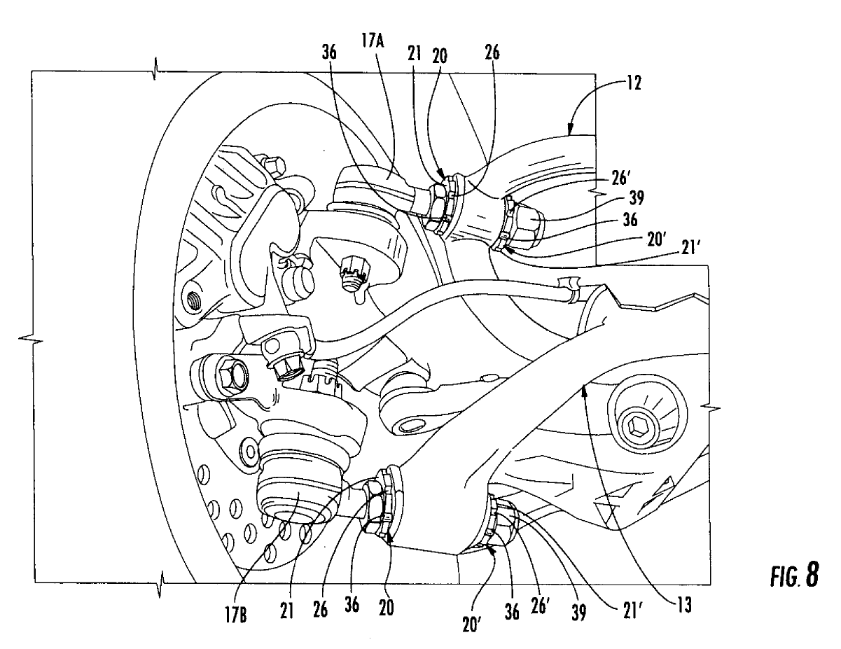

As shown in FIG. 7, the cams 20 and 20′ may be mounted in the upper suspension member 12 on the ATV 10. The cams 20 and 20′ are initially installed on the ATV 10 with a center one of the notches 26 and 26′ engaging the engagement members 36. This produces a neutral caster condition. When an operator wants to change the wheel caster of the ATV 10, the nut 39 of the ball joint 17A is loosened to allow the cams 20 and 20′ to disengage the engagement members 36. The cams 20 and 20′ are then rotated either clockwise or counter-clockwise depending on the type of caster the operator desires. By rotating the cams 20 and 20′ clockwise, positive caster is attained, thereby reducing steering effort, increasing directional stability, and improving turn-in. This is particularly useful for younger riders who need an ATV that steers easily or for racers who desire specific steering characteristics for a particular race. By rotating the cams 20 and 20′ counter-clockwise, negative caster is attained, thereby increasing steering effort and increasing steering stability over rough terrain. Once the cams 20 and 20′ have been re-positioned, the ball joint 38 is re-tightened to secure the ball joint 17A and cams 20 and 20′ in the desired position.

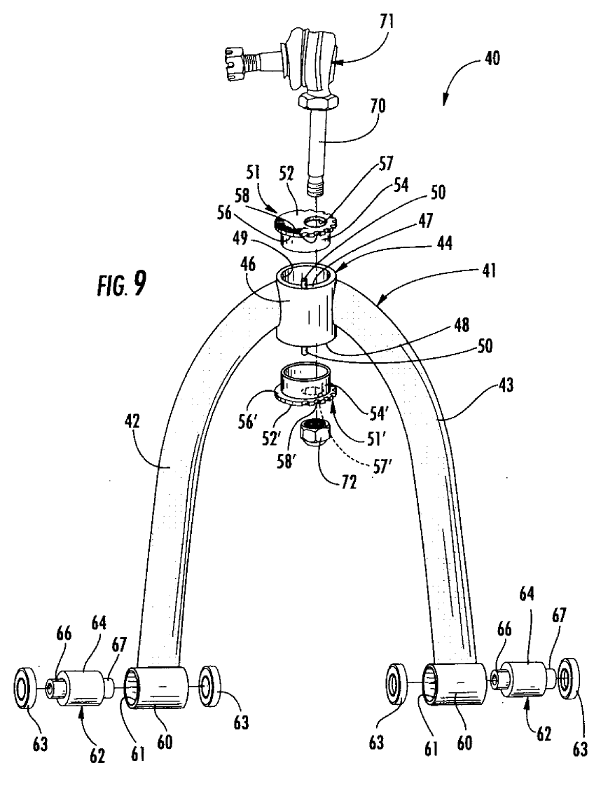

Referring to FIG. 8, the cams 20 and 20′ may also be mounted in both the upper 12 and lower 13 suspension members of the ATV 10. By using the cams 20 and 20′ in the upper and lower suspension members 12 and 13, not only can the wheel caster be changed as described above, but the wheelbase of the ATV 10 can be lengthened or shortened. By rotating the cams 20 and 20′ clockwise, the wheelbase is lengthened. Rotating the cams 20 and 20′ counter-clockwise shortens the wheel base.

FIG. 9 illustrates a suspension member assembly according to an alternative embodiment of the invention. The suspension member assembly 40 includes a suspension member 41 having a pair of elongate members 42 and 43 joined at an end 44. The end 44 includes a ball joint mount 46 having a top surface 47, a bottom surface 48, an aperture 49, and engagement members 50 extending from the top surface 47 and bottom surface 48 at predetermined locations. The suspension member assembly 40 also includes a pair of opposing cams 51 and 51′ for being inserted into the aperture 49 of the ball joint mount 46. Like the cams 20 and 20′, the cams 51 and 51′ include flanges 52 and 52′, sleeves 54 and 54′ extending from bottom surfaces 56 and 56′, off-axis apertures 57 and 57′, and a plurality of notches 58 and 58′ for engaging the engagement members 50. Each of the elongate members 42 and 43 include a frame mount 60 having an aperture 61 therethrough for accepting an insert 62 and bearings, such as roller bearings 63, positioned on opposing ends of the insert 62, thereby eliminating the need for bushings and increasing durability. As shown, the insert 62 includes a center section 64 and two bearing sections 66 and 67 positioned on opposing sides of the center section 64 for allowing a respective one of the bearings 63 to be supported thereon.

The suspension member assembly 40 is assembled by positioning a portion of the sleeves 54 and 54′ of the opposing cams 51 and 51′ within the aperture 49 until the respective flanges 52 and 52′ of each of the cams 51 and 51′ rest adjacent to respective top and bottom surfaces 47 and 48 of the ball joint mount 46. The cam 51 adjacent to the top surface 47 is then rotated to a predetermined position so that a desired one of the notches 58 is aligned with the engagement member 50 extending from the top surface 47. The cam 51 is then pushed further into the aperture 49 until the bottom surface 56 comes into contact with the top surface 47 of the ball joint mount 46. The cam 51′ adjacent the bottom surface 48 is then rotated so that the off-axis apertures 57 and 57′ are in alignment with each other. The cam 51′ is then pushed further into the aperture 49 until the bottom surface 56′ comes into contact with the bottom surface 48 of the ball joint mount 46. A post 70 of a ball joint 71 is then inserted through the off-axis apertures 57 and 57′ of the two cams 51 and 51′ and secured to the ball joint mount 46 by an attachment means, such as a nut 72. Each of the inserts 62 are then positioned within a respective frame mount 60. Once the inserts 62 are installed, each of the bearings 63 are positioned on respective bearing sections 66 and 67 of the inserts 62. The suspension member assembly may be used as a replacement for the upper suspension member 12, the lower suspension member 13, or both.

A caster adjustment apparatus, suspension member assembly, and method are described above. Various details of the invention may be changed without departing from its scope. Furthermore, the foregoing description of the preferred embodiments of the invention and the best mode for practicing the invention are provided for the purpose of illustration only and not for the purpose of limitation.

I claim:

1. A caster adjustment apparatus for being positioned in a ball joint mount of a suspension member, comprising:
(a) a flange, including:
(i) an aperture extending through the flange for receiving a ball joint therethrough, wherein a center of the aperture is offset from a center of the flange;
(ii) a plurality of openings positioned around a periphery of the flange at predetermined positions for engagement with an engagement member positioned on the ball joint mount; and
(b) a cylindrical sleeve extending from a bottom surface of the flange for being received in the ball joint mount.

2. The caster adjustment apparatus according to claim 1, wherein the openings are notches.

3. The caster adjustment apparatus according to claim 1, wherein the plurality of openings are spaced-apart in predetermined increments.

4. The caster adjustment apparatus according to claim 1, wherein the bottom surface of the flange is adapted to abut against the ball joint mount.

5. The caster adjustment apparatus according to claim 1, wherein the sleeve is adapted to be positioned within an aperture of the ball joint mount.

6. The caster adjustment apparatus according to claim 1, wherein the flange has a diameter greater than the diameter of the sleeve such that when the sleeve is positioned in the ball joint mount, the flange interferes with a top edge of the ball joint mount to provide a stop.

7. A caster adjustment assembly, comprising:
(a) a suspension member for being mounted between a vehicle frame and a vehicle wheel assembly, the suspension member having:
(i) a ball joint mount positioned for receiving a ball joint therein to connect the suspension member to the wheel assembly; and
(ii) an engagement member positioned on the ball joint mount;
(b) a first cam positioned in a fist side of the ball joint mount for receiving and adjusting the position of the ball joint, the cam comprising:
(i) a flange having an aperture extending through the flange for receiving the ball joint therethrough, and a plurality of openings positioned around a periphery of the flange at predetermined positions for engagement with the engagement member, wherein a center of the aperture is offset from a center of the flange; and
(ii) a cylindrical sleeve extending from a bottom surface of the flange, the sleeve being received in the ball joint mount;
(c) wherein at least one of the openings is engaged with the engagement member to secure the cam at a selected angular orientation relative to the ball joint mount.

8. The caster adjustment assembly according to claim 7, wherein the engagement member is positioned on the first side of the ball joint mount.

9. The caster adjustment assembly according to claim 7, wherein the plurality of openings are notches.

10. The caster adjustment assembly according to claim 7, wherein a stud of the ball joint is positioned through the aperture.

11. The caster adjustment assembly according to claim 7, and further including a second cam positioned on a second side of the ball joint mount.

12. The caster adjustment assembly according to claim 12, wherein the second cam includes:
(a) a flange having an aperture extending through the flange for receiving the ball joint therethrough, and a plurality of openings positioned around a periphery of the flange at predetermined positions for engagement with an engagement member positioned on a second side of the ball joint mount, wherein a center of the aperture is offset from a center of the flange; and
(b) a cylindrical sleeve extending from a bottom surface of the flange, the sleeve being received in the ball joint mount.

13. The caster adjustment assembly according to claim 12, wherein the plurality of openings are notches.

14. The caster adjustment assembly according to claim 11, wherein the first cam and the second cam are positioned in opposing sides of the ball joint mount such that the apertures extending through the flanges are aligned to receive the ball joint therethrough.

15. A method of adjusting the caster of a vehicle wheel, comprising the steps of:
(a) providing a first caster adjustment apparatus having an aperture extending through a flange for receiving a ball joint therethrough;
(b) positioning the first caster adjustment apparatus in a ball joint mount;
(c) positioning the ball joint in the aperture; and
(d) securing the ball joint to the ball joint mount.

16. The method according to claim 15, and further including the step of removing a bushing from the ball joint mount.

17. The method according to claim 15, and further including the step of rotating the caster adjustment apparatus to a predetermined position such that an opening in a flange of the caster adjustment apparatus engages an engagement member on the ball joint mount.

18. The method according to claim 15, and further including the steps of:
(a) providing a second caster adjustment apparatus having an aperture extending through a flange for receiving a ball joint therethrough; and
(b) positioning the second caster adjustment apparatus in a second opposing side of the ball joint mount.

19. The method according to claim 19, and further including the step of rotating the second caster adjustment apparatus such that the aperture of the second caster adjustment apparatus is aligned with the aperture of the first caster adjustment apparatus for receiving the ball joint therethrough.

20. The method according to claim 15, and further including the step of securing a wheel assembly to the ball joint.
